(19) United States
(12) Patent Application Publication
(10) Pub. No.: US 2024/0256322 A1
(43) Pub. Date: Aug. 1, 2024

(54) Systems and Methods for Enhanced Clones of vVol-based Virtual Machines

(71) Applicant: Dell Products L.P., Round Rock, TX (US)

(72) Inventors: Fedor Kusov, Bishoptown (IE); Vasudevan Subramanian, Chapel Hill, NC (US); Alexey Shusharin, Yadro (RU)

(21) Appl. No.: 18/162,461

(22) Filed: Jan. 31, 2023

(51) Int. Cl. G06F 9/455

(52) U.S. Cl. CPC G06F 9/45558; G06F 2009/4557; G06F 2009/45583

(57) ABSTRACT

A method, computer program product, and computer system for identifying, by a computing device, that virtual volumes clustered on a first storage appliance are part of a template. The virtual volumes may be marked as read-only based upon, at least in part, identifying that the virtual volumes are part of the template. A clone of the template may be created for the virtual volumes, the clone stored locally on a second storage appliance. A new virtual machine may be provisioned on the second storage appliance by using the clone of the template for the virtual volumes locally stored on the second storage appliance.

### BACKGROUND

Multiple data storage appliances may be clustered. In a cluster, virtual volumes (vVols) are distributed across appliances, which may be exposed as a single stretched storage container that is mounted as a single vVol datastore on hosts. Hosts accessing the vVol datastore for storage are not aware that the stretched storage container is across multiple appliances in a cluster.

### BRIEF SUMMARY OF DISCLOSURE

In one example implementation, a method, performed by one or more computing devices, may include but is not limited to identifying, by a computing device, that virtual volumes clustered on a first storage appliance are part of a template. The virtual volumes may be marked as read-only based upon, at least in part, identifying that the virtual volumes are part of the template. A clone of the template may be created for the virtual volumes, the clone stored locally on a second storage appliance. A new virtual machine may be provisioned on the second storage appliance by using the clone of the template for the virtual volumes locally stored on the second storage appliance.

One or more of the following example features may be included. Creating the clone may include selecting one of the first storage appliance and the second storage appliance to store a configuration virtual volume. Creating the clone may further include initiating an automated migration of the configuration virtual volume between the first storage appliance and the second storage appliance. Creating the clone may include identifying an existing shadow template for a data virtual volume. Creating the clone may include creating a shadow template for a data virtual volume when the shadow template does not exist. Creating the clone may include creating a data virtual volume clone using a shadow template. Changes made to the template may be applied to all further clones of the template.

In another example implementation, a computing system may include one or more processors and one or more memories configured to perform operations that may include but are not limited to identifying that virtual volumes clustered on a first storage appliance are part of a template. The virtual volumes may be marked as read-only based upon, at least in part, identifying that the virtual volumes are part of the template. A clone of the template may be created for the virtual volumes, the clone stored locally on a second storage appliance. A new virtual machine may be provisioned on the second storage appliance by using the clone of the template for the virtual volumes locally stored on the second storage appliance.

One or more of the following example features may be included. Creating the clone may include selecting one of the first storage appliance and the second storage appliance to store a configuration virtual volume. Creating the clone may further include initiating an automated migration of the configuration virtual volume between the first storage appliance and the second storage appliance. Creating the clone may include identifying an existing shadow template for a data virtual volume. Creating the clone may include creating a shadow template for a data virtual volume when the shadow template does not exist. Creating the clone may include creating a data virtual volume clone using a shadow template. Changes made to the template may be applied to all further clones of the template.

In another example implementation, a computer program product may reside on a computer readable storage medium having a plurality of instructions stored thereon which, when executed across one or more processors, may cause at least a portion of the one or more processors to perform operations that may include but are not limited to identifying that virtual volumes clustered on a first storage appliance are part of a template. The virtual volumes may be marked as read-only based upon, at least in part, identifying that the virtual volumes are part of the template. A clone of the template may be created for the virtual volumes, the clone stored locally on a second storage appliance. A new virtual machine may be provisioned on the second storage appliance by using the clone of the template for the virtual volumes locally stored on the second storage appliance.

One or more of the following example features may be included. Creating the clone may include selecting one of the first storage appliance and the second storage appliance to store a configuration virtual volume. Creating the clone may further include initiating an automated migration of the configuration virtual volume between the first storage appliance and the second storage appliance. Creating the clone may include identifying an existing shadow template for a data virtual volume. Creating the clone may include creating a shadow template for a data virtual volume when the shadow template does not exist. Creating the clone may include creating a data virtual volume clone using a shadow template. Changes made to the template may be applied to all further clones of the template.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a clone process coupled to an example distributed computing network according to one or more example implementations of the disclosure;

FIG. 2 is an example diagrammatic view of a storage system of FIG. 1 according to one or more example implementations of the disclosure;

FIG. 3 is an example diagrammatic view of a storage target of a storage system according to one or more example implementations of the disclosure;

FIG. 4 is an example diagrammatic view of a cluster of a storage system according to one or more example implementations of the disclosure;

FIG. 5 is an example diagrammatic view of a cluster of FIG. 1 according to one or more example implementations of the disclosure;

FIG. 6 is an example flowchart of a clone process according to one or more example implementations of the disclosure; and

FIG. 7 is an example flowchart of a clone process according to one or more example implementations of the disclosure.

Like reference symbols in the various drawings indicate like elements.

### DETAILED DESCRIPTION

### System Overview:

In some implementations, the present disclosure may be embodied as a method, system, or computer program product. Accordingly, in some implementations, the present disclosure may take the form of an entirely hardware implementation, an entirely software implementation (including firmware, resident software, micro-code, etc.) or an implementation combining software and hardware aspects that may all generally be referred to herein as a “circuit,” “module” or “system.” Furthermore, in some implementations, the present disclosure may take the form of a computer program product on a computer-usable storage medium having computer-usable program code embodied in the medium.

In some implementations, any suitable computer usable or computer readable medium (or media) may be utilized. The computer readable medium may be a computer readable signal medium or a computer readable storage medium. The computer-usable, or computer-readable, storage medium (including a storage device associated with a computing device or client electronic device) may be, for example, but is not limited to, an electronic, magnetic, optical, electromagnetic, infrared, or semiconductor system, apparatus, device, or any suitable combination of the foregoing. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a digital versatile disk (DVD), a static random access memory (SRAM), a memory stick, a floppy disk, a mechanically encoded device such as punch-cards or raised structures in a groove having instructions recorded thereon, a media such as those supporting the internet or an intranet, or a magnetic storage device. Note that the computer-usable or computer-readable medium could even be a suitable medium upon which the program is stored, scanned, compiled, interpreted, or otherwise processed in a suitable manner, if necessary, and then stored in a computer memory. In the context of the present disclosure, a computer-usable or computer-readable, storage medium may be any tangible medium that can contain or store a program for use by or in connection with the instruction execution system, apparatus, or device.

In some implementations, a computer readable signal medium may include a propagated data signal with computer readable program code embodied therein, for example, in baseband or as part of a carrier wave. In some implementations, such a propagated signal may take any of a variety of forms, including, but not limited to, electro-magnetic, optical, or any suitable combination thereof. In some implementations, the computer readable program code may be transmitted using any appropriate medium, including but not limited to the internet, wireline, optical fiber cable, RF, etc. In some implementations, a computer readable signal medium may be any computer readable medium that is not a computer readable storage medium and that can communicate, propagate, or transport a program for use by or in connection with an instruction execution system, apparatus, or device.

In some implementations, computer program code for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java®, Smalltalk, C++ or the like. Java® and all Java-based trademarks and logos are trademarks or registered trademarks of Oracle and/or its affiliates. However, the computer program code for carrying out operations of the present disclosure may also be written in conventional procedural programming languages, such as the “C” programming language, PASCAL, or similar programming languages, as well as in scripting languages such as Javascript, PERL, or Python. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the internet using an Internet Service Provider). In some implementations, electronic circuitry including, for example, programmable logic circuitry, field-programmable gate arrays (FPGAs) or other hardware accelerators, micro-controller units (MCUs), or programmable logic arrays (PLAs) may execute the computer readable program instructions/code by utilizing state information of the computer readable program instructions to personalize the electronic circuitry, in order to perform aspects of the present disclosure.

In some implementations, the flowchart and block diagrams in the figures illustrate the architecture, functionality, and operation of possible implementations of apparatus (systems), methods and computer program products according to various implementations of the present disclosure. Each block in the flowchart and/or block diagrams, and combinations of blocks in the flowchart and/or block diagrams, may represent a module, segment, or portion of code, which comprises one or more executable computer program instructions for implementing the specified logical function(s)/act(s). These computer program instructions may be provided to a processor of a general purpose computer, special purpose computer, or other programmable data processing apparatus to produce a machine, such that the computer program instructions, which may execute via the processor of the computer or other programmable data processing apparatus, create the ability to implement one or more of the functions/acts specified in the flowchart and/or block diagram block or blocks or combinations thereof. It should be noted that, in some implementations, the functions noted in the block(s) may occur out of the order noted in the figures (or combined or omitted). For example, two blocks shown in succession may, in fact, be executed substantially concurrently, or the blocks may sometimes be executed in the reverse order, depending upon the functionality involved.

In some implementations, these computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks or combinations thereof.

In some implementations, the computer program instructions may also be loaded onto a computer or other programmable data processing apparatus to cause a series of operational steps to be performed (not necessarily in a particular order) on the computer or other programmable apparatus to produce a computer implemented process such that the instructions which execute on the computer or other programmable apparatus provide steps for implementing the functions/acts (not necessarily in a particular order) specified in the flowchart and/or block diagram block or blocks or combinations thereof.

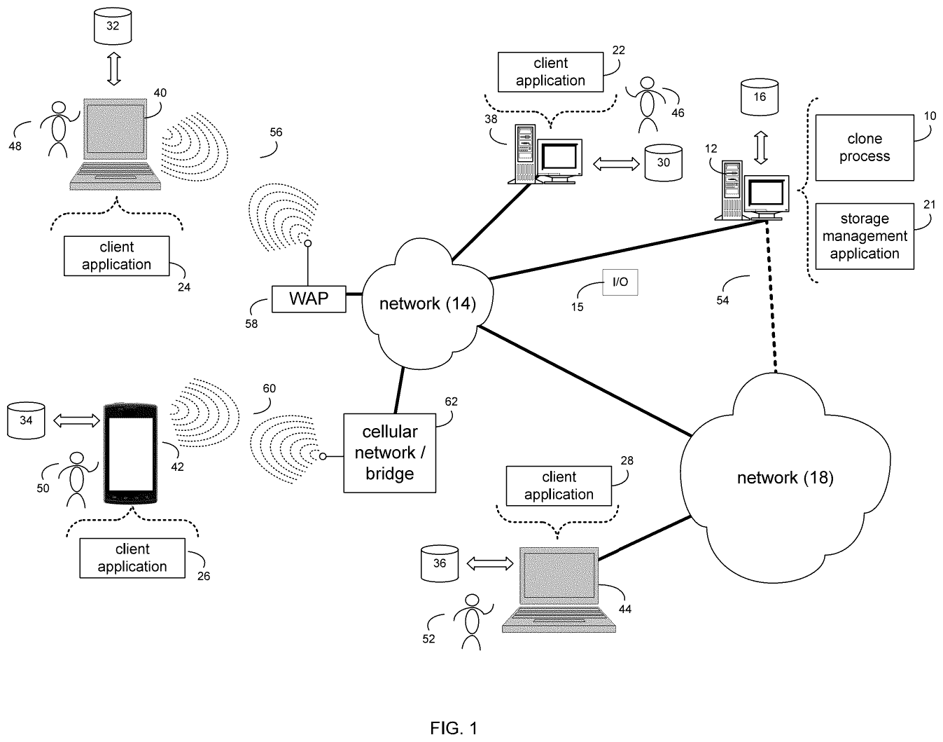

Referring now to the example implementation of FIG. 1, there is shown clone process 10 that may reside on and may be executed by a computer (e.g., computer 12), which may be connected to a network (e.g., network 14) (e.g., the internet or a local area network). Examples of computer 12 (and/or one or more of the client electronic devices noted below) may include, but are not limited to, a storage system (e.g., a Network Attached Storage (NAS) system, a Storage Area Network (SAN)), a personal computer(s), a laptop computer(s), mobile computing device(s), a server computer, a series of server computers, a mainframe computer(s), or a computing cloud(s). As is known in the art, a SAN may include one or more of the client electronic devices, including a Redundant Array of Inexpensive Disks/Redundant Array of Independent Disks (RAID) device and a NAS system. In some implementations, each of the aforementioned may be generally described as a computing device. In certain implementations, a computing device may be a physical or virtual device. In many implementations, a computing device may be any device capable of performing operations, such as a dedicated processor, a portion of a processor, a virtual processor, a portion of a virtual processor, portion of a virtual device, or a virtual device. In some implementations, a processor may be a physical processor or a virtual processor. In some implementations, a virtual processor may correspond to one or more parts of one or more physical processors. In some implementations, the instructions/logic may be distributed and executed across one or more processors, virtual or physical, to execute the instructions/logic. Computer 12 may execute an operating system, for example, but not limited to, Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a clone process, such as clone process 10 of FIG. 1, may identify, by a computing device, that virtual volumes clustered on a first storage appliance are part of a template. The virtual volumes may be marked as read-only based upon, at least in part, identifying that the virtual volumes are part of the template. A clone of the template may be created for the virtual volumes, the clone stored locally on a second storage appliance. A new virtual machine may be provisioned on the second storage appliance by using the clone of the template for the virtual volumes locally stored on the second storage appliance.

In some implementations, the instruction sets and subroutines of clone process 10, which may be stored on storage device, such as storage device 16, coupled to computer 12, may be executed by one or more processors and one or more memory architectures included within computer 12. In some implementations, storage device 16 may include but is not limited to: a hard disk drive; all forms of flash memory storage devices; a tape drive; an optical drive; a RAID array (or other array); a random access memory (RAM); a read-only memory (ROM); or combination thereof. In some implementations, storage device 16 may be organized as an extent, an extent pool, a RAID extent (e.g., an example 4D+1P R5, where the RAID extent may include, e.g., five storage device extents that may be allocated from, e.g., five different storage devices), a mapped RAID (e.g., a collection of RAID extents), or combination thereof.

In some implementations, network 14 may be connected to one or more secondary networks (e.g., network 18), examples of which may include but are not limited to: a local area network; a wide area network or other telecommunications network facility; or an intranet, for example. The phrase “telecommunications network facility,” as used herein, may refer to a facility configured to transmit, and/or receive transmissions to/from one or more mobile client electronic devices (e.g., cellphones, etc.) as well as many others.

In some implementations, computer 12 may include a data store, such as a database (e.g., relational database, object-oriented database, triplestore database, etc.) and may be located within any suitable memory location, such as storage device 16 coupled to computer 12. In some implementations, data, metadata, information, etc. described throughout the present disclosure may be stored in the data store. In some implementations, computer 12 may utilize any known database management system such as, but not limited to, DB2, in order to provide multi-user access to one or more databases, such as the above noted relational database. In some implementations, the data store may also be a custom database, such as, for example, a flat file database or an XML database. In some implementations, any other form(s) of a data storage structure and/or organization may also be used. In some implementations, clone process 10 may be a component of the data store, a standalone application that interfaces with the above noted data store and/or an applet/application that is accessed via client applications 22, 24, 26, 28. In some implementations, the above noted data store may be, in whole or in part, distributed in a cloud computing topology. In this way, computer 12 and storage device 16 may refer to multiple devices, which may also be distributed throughout the network.

In some implementations, computer 12 may execute a storage management application (e.g., storage management application 21), examples of which may include, but are not limited to, e.g., a storage system application, a cloud computing application, a data synchronization application, a data migration application, a garbage collection application, or other application that allows for the implementation and/or management of data in a clustered (or non-clustered) environment (or the like). In some implementations, clone process 10 and/or storage management application 21 may be accessed via one or more of client applications 22, 24, 26, 28. In some implementations, clone process 10 may be a standalone application, or may be an applet/application/script/extension that may interact with and/or be executed within storage management application 21, a component of storage management application 21, and/or one or more of client applications 22, 24, 26, 28. In some implementations, storage management application 21 may be a standalone application, or may be an applet/application/script/extension that may interact with and/or be executed within clone process 10, a component of clone process 10, and/or one or more of client applications 22, 24, 26, 28. In some implementations, one or more of client applications 22, 24, 26, 28 may be a standalone application, or may be an applet/application/script/extension that may interact with and/or be executed within and/or be a component of clone process 10 and/or storage management application 21. Examples of client applications 22, 24, 26, 28 may include, but are not limited to, e.g., a storage system application, a cloud computing application, a data synchronization application, a data migration application, a garbage collection application, or other application that allows for the implementation and/or management of data in a clustered (or non-clustered) environment (or the like), a standard and/or mobile web browser, an email application (e.g., an email client application), a textual and/or a graphical user interface, a customized web browser, a plugin, an Application Programming Interface (API), or a custom application. The instruction sets and subroutines of client applications 22, 24, 26, 28, which may be stored on storage devices 30, 32, 34, 36, coupled to client electronic devices 38, 40, 42, 44, may be executed by one or more processors and one or more memory architectures incorporated into client electronic devices 38, 40, 42, 44.

In some implementations, one or more of storage devices 30, 32, 34, 36, may include but are not limited to: hard disk drives; flash drives, tape drives; optical drives; RAID arrays; random access memories (RAM); and read-only memories (ROM). Examples of client electronic devices 38, 40, 42, 44 (and/or computer 12) may include, but are not limited to, a personal computer (e.g., client electronic device 38), a laptop computer (e.g., client electronic device 40), a smart/data-enabled, cellular phone (e.g., client electronic device 42), a notebook computer (e.g., client electronic device 44), a tablet, a server, a television, a smart television, a smart speaker, an Internet of Things (IoT) device, a media (e.g., video, photo, etc.) capturing device, and a dedicated network device. Client electronic devices 38, 40, 42, 44 may each execute an operating system, examples of which may include but are not limited to, Android™, Apple® iOS®, Mac® OS X®; Red Hat® Linux®, Windows® Mobile, Chrome OS, Blackberry OS, Fire OS, or a custom operating system.

In some implementations, one or more of client applications 22, 24, 26, 28 may be configured to effectuate some or all of the functionality of clone process 10 (and vice versa). Accordingly, in some implementations, clone process 10 may be a purely server-side application, a purely client-side application, or a hybrid server-side/client-side application that is cooperatively executed by one or more of client applications 22, 24, 26, 28 and/or clone process 10.

In some implementations, one or more of client applications 22, 24, 26, 28 may be configured to effectuate some or all of the functionality of storage management application 21 (and vice versa). Accordingly, in some implementations, storage management application 21 may be a purely server-side application, a purely client-side application, or a hybrid server-side/client-side application that is cooperatively executed by one or more of client applications 22, 24, 26, 28 and/or storage management application 21. As one or more of client applications 22, 24, 26, 28, clone process 10, and storage management application 21, taken singly or in any combination, may effectuate some or all of the same functionality, any description of effectuating such functionality via one or more of client applications 22, 24, 26, 28, clone process 10, storage management application 21, or combination thereof, and any described interaction(s) between one or more of client applications 22, 24, 26, 28, clone process 10, storage management application 21, or combination thereof to effectuate such functionality, should be taken as an example only and not to limit the scope of the disclosure.

In some implementations, one or more of users 46, 48, 50, 52 may access computer 12 and clone process 10 (e.g., using one or more of client electronic devices 38, 40, 42, 44) directly through network 14 or through secondary network 18. Further, computer 12 may be connected to network 14 through secondary network 18, as illustrated with phantom link line 54. Clone process 10 may include one or more user interfaces, such as browsers and textual or graphical user interfaces, through which users 46, 48, 50, 52 may access clone process 10.

In some implementations, the various client electronic devices may be directly or indirectly coupled to network 14 (or network 18). For example, client electronic device 38 is shown directly coupled to network 14 via a hardwired network connection. Further, client electronic device 44 is shown directly coupled to network 18 via a hardwired network connection. Client electronic device 40 is shown wirelessly coupled to network 14 via wireless communication channel 56 established between client electronic device 40 and wireless access point (i.e., WAP) 58, which is shown directly coupled to network 14. WAP 58 may be, for example, an IEEE 802.11a, 802.11b, 802.11g, 802.11n, 802.11ac, Wi-Fi®, RFID, and/or Bluetooth™ (including Bluetooth™ Low Energy) device that is capable of establishing wireless communication channel 56 between client electronic device 40 and WAP 58. Client electronic device 42 is shown wirelessly coupled to network 14 via wireless communication channel 60 established between client electronic device 42 and cellular network/bridge 62, which is shown by example directly coupled to network 14.

In some implementations, some or all of the IEEE 802.11x specifications may use Ethernet protocol and carrier sense multiple access with collision avoidance (i.e., CSMA/CA) for path sharing. The various 802.11x specifications may use phase-shift keying (i.e., PSK) modulation or complementary code keying (i.e., CCK) modulation, for example. Bluetooth™ (including Bluetooth™ Low Energy) is a telecommunications industry specification that allows, e.g., mobile phones, computers, smart phones, and other electronic devices to be interconnected using a short-range wireless connection. Other forms of interconnection (e.g., Near Field Communication (NFC)) may also be used.

In some implementations, various I/O requests (e.g., I/O request 15) may be sent from, e.g., client applications 22, 24, 26, 28 to, e.g., computer 12. Examples of I/O request 15 may include but are not limited to, data write requests (e.g., a request that content be written to computer 12) and data read requests (e.g., a request that content be read from computer 12).

### Data Storage System:

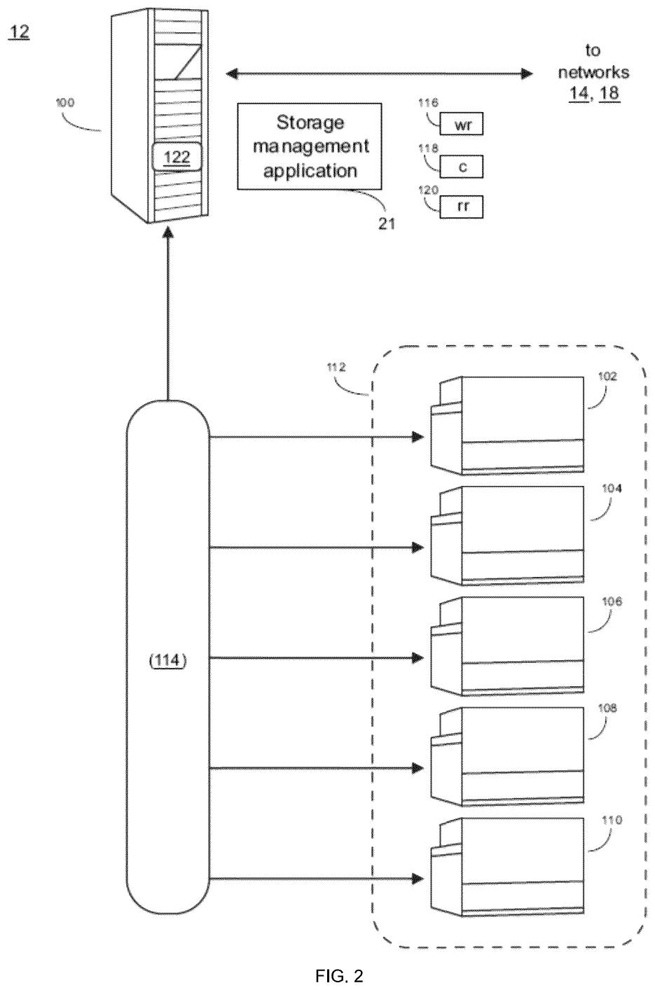

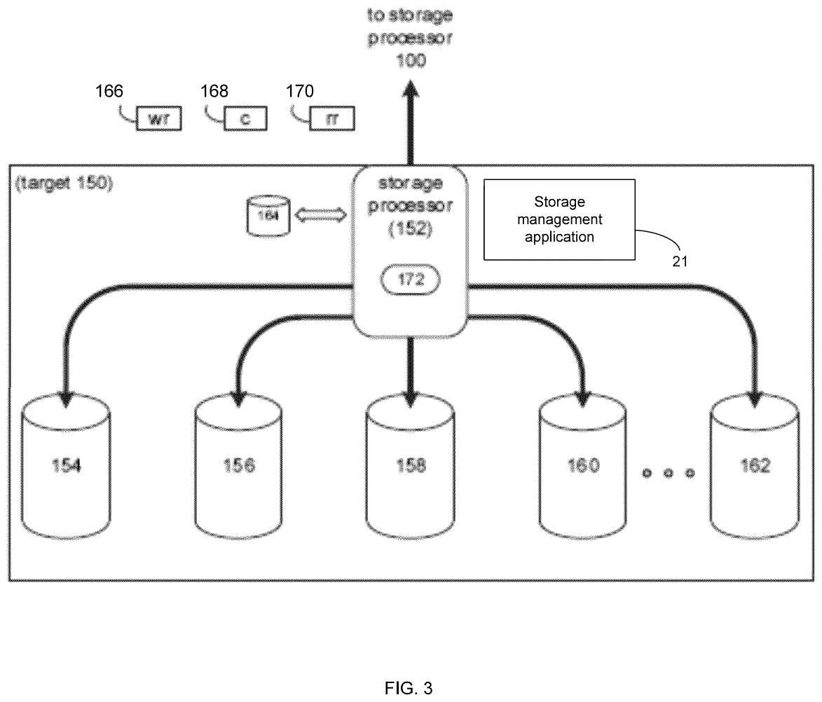

Referring also to the example implementation of FIGS. 2-3 (e.g., where computer 12 may be configured as a data storage system), computer 12 may include storage processor 100 and a plurality of storage targets (e.g., storage targets 102, 104, 106, 108, 110). In some implementations, storage targets 102, 104, 106, 108, 110 may include any of the above-noted storage devices. In some implementations, storage targets 102, 104, 106, 108, 110 may be configured to provide various levels of performance and/or high availability. For example, storage targets 102, 104, 106, 108, 110 may be configured to form a non-fully-duplicative fault-tolerant data storage system (such as a non-fully-duplicative RAID data storage system), examples of which may include but are not limited to: RAID 3 arrays, RAID 4 arrays, RAID 5 arrays, and/or RAID 6 arrays. It will be appreciated that various other types of RAID arrays may be used without departing from the scope of the present disclosure.

While in this particular example, computer 12 is shown to include five storage targets (e.g., storage targets 102, 104, 106, 108, 110), this is for example purposes only and is not intended limit the present disclosure. For instance, the actual number of storage targets may be increased or decreased depending upon, e.g., the level of redundancy/performance/capacity required.

Further, the storage targets (e.g., storage targets 102, 104, 106, 108, 110) included with computer 12 may be configured to form a plurality of discrete storage arrays. For instance, and assuming for example purposes only that computer 12 includes, e.g., ten discrete storage targets, a first five targets (of the ten storage targets) may be configured to form a first RAID array and a second five targets (of the ten storage targets) may be configured to form a second RAID array.

In some implementations, one or more of storage targets 102, 104, 106, 108, 110 may be configured to store coded data (e.g., via storage management process 21), wherein such coded data may allow for the regeneration of data lost/corrupted on one or more of storage targets 102, 104, 106, 108, 110. Examples of such coded data may include but is not limited to parity data and Reed-Solomon data. Such coded data may be distributed across all of storage targets 102, 104, 106, 108, 110 or may be stored within a specific storage target.

Examples of storage targets 102, 104, 106, 108, 110 may include one or more data arrays, wherein a combination of storage targets 102, 104, 106, 108, 110 (and any processing/control systems associated with storage management application 21) may form data array 112.

The manner in which computer 12 is implemented may vary depending upon e.g., the level of redundancy/performance/capacity required. For example, computer 12 may be configured as a SAN (i.e., a Storage Area Network), in which storage processor 100 may be, e.g., a dedicated computing system and each of storage targets 102, 104, 106, 108, 110 may be a RAID device. An example of storage processor 100 may include but is not limited to a VPLEX™, VNX™, PowerStore™, or Unity™ system offered by Dell EMC™ of Hopkinton, MA.

In the example where computer 12 is configured as a SAN, the various components of computer 12 (e.g., storage processor 100, and storage targets 102, 104, 106, 108, 110) may be coupled using network infrastructure 114, examples of which may include but are not limited to an Ethernet (e.g., Layer 2 or Layer 3) network, a fiber channel network, an InfiniBand network, or any other circuit switched/packet switched network.

As discussed above, various I/O requests (e.g., I/O request 15) may be generated. For example, these I/O requests may be sent from, e.g., client applications 22, 24, 26, 28 to, e.g., computer 12. Additionally/alternatively (e.g., when storage processor 100 is configured as an application server or otherwise), these I/O requests may be internally generated within storage processor 100 (e.g., via storage management process 21). Examples of I/O request 15 may include but are not limited to data write request 116 (e.g., a request that content 118 be written to computer 12) and data read request 120 (e.g., a request that content 118 be read from computer 12).

In some implementations, during operation of storage processor 100, content 118 to be written to computer 12 may be received and/or processed by storage processor 100 (e.g., via storage management process 21). Additionally/alternatively (e.g., when storage processor 100 is configured as an application server or otherwise), content 118 to be written to computer 12 may be internally generated by storage processor 100 (e.g., via storage management process 21).

As discussed above, the instruction sets and subroutines of storage management application 21, which may be stored on storage device 16 included within computer 12, may be executed by one or more processors and one or more memory architectures included with computer 12. Accordingly, in addition to being executed on storage processor 100, some or all of the instruction sets and subroutines of storage management application 21 (and/or clone process 10) may be executed by one or more processors and one or more memory architectures included with data array 112.

In some implementations, storage processor 100 may include front end cache memory system 122. Examples of front end cache memory system 122 may include but are not limited to a volatile, solid-state, cache memory system (e.g., a dynamic RAM cache memory system), a non-volatile, solid-state, cache memory system (e.g., a flash-based, cache memory system), and/or any of the above-noted storage devices.

In some implementations, storage processor 100 may initially store content 118 within front end cache memory system 122. Depending upon the manner in which front end cache memory system 122 is configured, storage processor 100 (e.g., via storage management process 21) may immediately write content 118 to data array 112 (e.g., if front end cache memory system 122 is configured as a write-through cache) or may subsequently write content 118 to data array 112 (e.g., if front end cache memory system 122 is configured as a write-back cache).

In some implementations, one or more of storage targets 102, 104, 106, 108, 110 may include a backend cache memory system. Examples of the backend cache memory system may include but are not limited to a volatile, solid-state, cache memory system (e.g., a dynamic RAM cache memory system), a non-volatile, solid-state, cache memory system (e.g., a flash-based, cache memory system), and/or any of the above-noted storage devices.

### Storage Targets:

As discussed above, one or more of storage targets 102, 104, 106, 108, 110 may be a RAID device. For instance, and referring also to FIG. 3, there is shown example target 150, wherein target 150 may be one example implementation of a RAID implementation of, e.g., storage target 102, storage target 104, storage target 106, storage target 108, and/or storage target 110. An example of target 150 may include but is not limited to a VPLEX™, VNX™, PowerStore™, or Unity™ system offered by Dell EMC™ of Hopkinton, MA. Examples of storage devices 154, 156, 158, 160, 162 may include one or more electro-mechanical hard disk drives, one or more solid-state/flash devices, and/or any of the above-noted storage devices. It will be appreciated that while the term “disk” or “drive” may be used throughout, these may refer to and be used interchangeably with any types of appropriate storage devices as the context and functionality of the storage device permits.

In some implementations, target 150 may include storage processor 152 and a plurality of storage devices (e.g., storage devices 154, 156, 158, 160, 162). Storage devices 154, 156, 158, 160, 162 may be configured to provide various levels of performance and/or high availability (e.g., via storage management process 21). For example, one or more of storage devices 154, 156, 158, 160, 162 (or any of the above-noted storage devices) may be configured as a RAID 0 array, in which data is striped across storage devices. By striping data across a plurality of storage devices, improved performance may be realized. However, RAID 0 arrays may not provide a level of high availability. Accordingly, one or more of storage devices 154, 156, 158, 160, 162 (or any of the above-noted storage devices) may be configured as a RAID 1 array, in which data is mirrored between storage devices. By mirroring data between storage devices, a level of high availability may be achieved as multiple copies of the data may be stored within storage devices 154, 156, 158, 160, 162.

While storage devices 154, 156, 158, 160, 162 are discussed above as being configured in a RAID 0 or RAID 1 array, this is for example purposes only and not intended to limit the present disclosure, as other configurations are possible. For example, storage devices 154, 156, 158, 160, 162 may be configured as a RAID 3, RAID 4, RAID 5 or RAID 6 array.

While in this particular example, target 150 is shown to include five storage devices (e.g., storage devices 154, 156, 158, 160, 162), this is for example purposes only and not intended to limit the present disclosure. For instance, the actual number of storage devices may be increased or decreased depending upon, e.g., the level of redundancy/performance/capacity required.

In some implementations, one or more of storage devices 154, 156, 158, 160, 162 may be configured to store (e.g., via storage management process 21) coded data, wherein such coded data may allow for the regeneration of data lost/corrupted on one or more of storage devices 154, 156, 158, 160, 162. Examples of such coded data may include but are not limited to parity data and Reed-Solomon data. Such coded data may be distributed across all of storage devices 154, 156, 158, 160, 162 or may be stored within a specific storage device.

The manner in which target 150 is implemented may vary depending upon e.g., the level of redundancy/performance/capacity required. For example, target 150 may be a RAID device in which storage processor 152 is a RAID controller card and storage devices 154, 156, 158, 160, 162 are individual “hot-swappable” hard disk drives. Another example of target 150 may be a RAID system, examples of which may include but are not limited to an NAS (i.e., Network Attached Storage) device or a SAN (i.e., Storage Area Network).

In some implementations, storage target 150 may execute all or a portion of storage management application 21. The instruction sets and subroutines of storage management application 21, which may be stored on a storage device (e.g., storage device 164) coupled to storage processor 152, may be executed by one or more processors and one or more memory architectures included with storage processor 152. Storage device 164 may include but is not limited to any of the above-noted storage devices.

As discussed above, computer 12 may be configured as a SAN, wherein storage processor 100 may be a dedicated computing system and each of storage targets 102, 104, 106, 108, 110 may be a RAID device. Accordingly, when storage processor 100 processes data requests 116, 120, storage processor 100 (e.g., via storage management process 21) may provide the appropriate requests/content (e.g., write request 166, content 168 and read request 170) to, e.g., storage target 150 (which is representative of storage targets 102, 104, 106, 108 and/or 110).

In some implementations, during operation of storage processor 152, content 168 to be written to target 150 may be processed by storage processor 152 (e.g., via storage management process 21). Storage processor 152 may include cache memory system 172. Examples of cache memory system 172 may include but are not limited to a volatile, solid-state, cache memory system (e.g., a dynamic RAM cache memory system) and/or a non-volatile, solid-state, cache memory system (e.g., a flash-based, cache memory system). During operation of storage processor 152, content 168 to be written to target 150 may be received by storage processor 152 (e.g., via storage management process 21) and initially stored (e.g., via storage management process 21) within front end cache memory system 172.

Multiple data storage appliances may be clustered. In a cluster, virtual volumes (vVols) are distributed across appliances, which may be exposed as a single stretched storage container that is mounted as a single vVol datastore on hosts. Hosts accessing the vVol datastore for storage are not aware that the stretched storage container is across multiple appliances in a cluster. Users may use vCenter (or other similar management applications) for the management plane for vVol administration. VMware vSphere APIs for Storage Awareness (VASA) is a feature that allows vSphere hosts to gain insight into the storage types backing the datastores and enables vSphere to manage storage (e.g., an API specified by Vmware and used by vSphere in order to manage virtual volumes). vCenter interacts with the storage appliance via the VASA provider, which runs in the Master Control Path (CP) container in the cluster. All vVol requests on behalf of vCenter and the hosts are directed to the VASA provider. In a multi-appliance cluster, the placement decisions for new vVols and cloned vVols are made by a Resource Balancer (a component in PowerStore that helps make optimal placement decisions for volumes and vVols) when these requests are received by the VASA Provider.

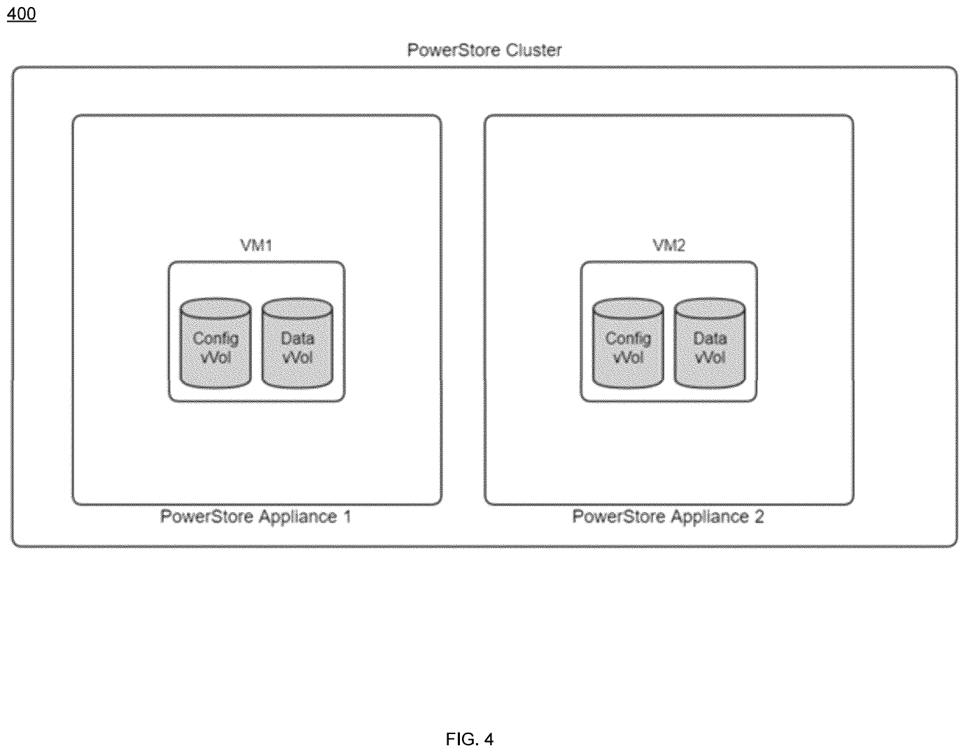

Referring to FIG. 4, an example PowerStore cluster 400 is shown with two vVol-based Virtual Machines provisioned on different appliances. It will be appreciated that a PowerStore cluster is just an example, and that other storage management architectures may be used without departing from the scope of the present disclosure. vVols is a VMware vSphere technology, which allows an individual virtual machine (VM) and its disks, rather than LUNs, to be a unit of storage management for a storage system. It will be appreciated that similar storage management architectures may be used without departing from the scope of the present disclosure. VMware vVols specification defines several types of vVols, including Config and Data. Config vVol is created for every VM and is used to store VM configuration. Data vVols represent VM hard disks. Config vVols are usually very small and may be around, e.g., 4 GB in size, while the data vVol could be as large as, e.g., 62 TB.

A Virtual Machine Template is an image of a VM that may include VM disks, devices, and settings. It will be appreciated that the term “disks” may include other types of storage devices. VM templates are used for deploying high numbers of similar VMs. A real-world example of VM template usage are VMs used by software engineers for development. Templates are used to create a working station for each developer/tester which means that one template can be used to provision hundreds of VMs. Deploying 100s of VMs on the same PowerStore (or other similar) appliance in a cluster can exceed the compute and storage capacity of one appliance in a scale-out PowerStore solution and is hence a poor utilization of the compute, networking, and storage resources on other appliances in the cluster. As will be discussed further below, the present disclosure proposes a solution to take full advantage of the PowerStore (or similar) scale-out architecture.

vVol-based VM templates may be stored as a set of vVols the same way as normal VMs are. VM templates cannot be powered on, and data stored on the template vVols are unmodifiable. When a VM is being deployed from a template, vSphere (or similar application) leverages a clone vVol operation to make an instance of the Data vVol. On the other hand, Config vVols of VM clones are created via usual create Virtual Volume operation.

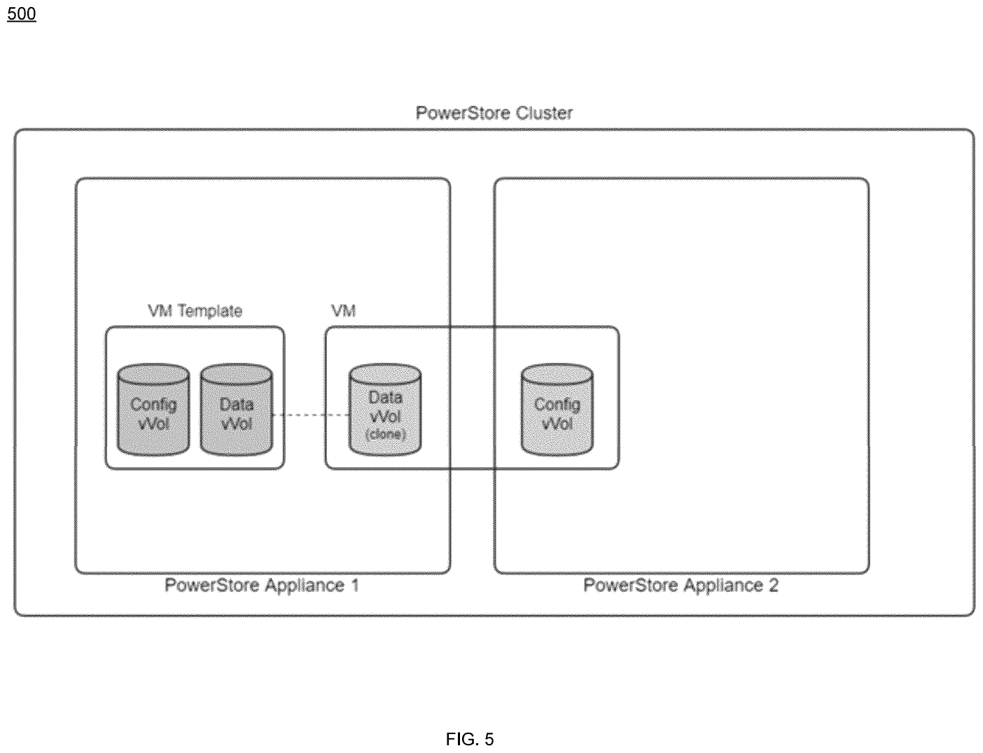

Assume for example purposes only that a VM template is stored in a cluster of PowerStore appliances. The template data is located on one of the appliances in the cluster. When a VM is deployed from a template, the Config vVol for the new VM may be created first. The PowerStore Resource Balancer has a chance to evaluate based on capacity and performance and usage metrics, which of the appliances should host the config vVol for this new VM. When customer wants to deploy a VM from a template the storage may decide to provision the Config vVol on another appliance then the template VM. However, in current implementations of clone operations for the data vVol in the VM, the clone for data vVol may be created on the same appliance where the template vVol lives. This means that Config and Data vVols of one VM will reside on different PowerStore appliances. For instance, and referring at least to FIG. 5, an example architecture 500 is shown demonstrating a situation when vVols of the clone VM are distributed across two appliances.

Currently, clone vVol in PowerStore translates to a space-efficient clone and is the same technique as used for vVol snapshots. This approach has example and non-limiting advantages (e.g., good performance on clone creation and simple implementation; however, there are also example and non-limiting issues:

(1) a specific VM's vVols are not co-located on same appliance. Appliance of the config vVol is selected by resource balancer, whereas clones of data vVols are always on the same appliance as their parents.

(2) replication requires manual intervention to work. Replication requires creation of consistent vVol snapshots, which may be difficult or even impossible across two appliances. Customers must migrate Config vVol to appliance hosting data vVol to make replication work.

(3) no balance between appliances, as all clones reside on the same appliance.

(4) vVol family limit, as there cannot be more than, e.g., 1000 derivatives (e.g., snapshots, space-efficient clones) of a vVol. If, for example, each VM has 10 snapshots, no more than 100 clones from the same template can be created.

Thus, the simple approach of copying data to another appliance during each clone operation has a major example and non-limiting drawback. The problem is that the same data will be copied between appliances each time a new VM is provisioned. Repeated migration of clones from one appliance to another will impact performance of other resources running on both appliances. Therefore, as will be discussed in greater detail below, the present disclosure may provide a way to clone Data vVols to different appliances and avoid excessive copying, leveraging the fact that VM templates' data are read-only. This copy of the original template on other appliances in the cluster is referenced as a shadow template. The present disclosure may leverage the data immutability of VM templates to optimize the cloning process, by, e.g., identifying that vVols are a part of a template and mark them read-only, and cloning template vVols between appliances once and use the local template copies on that appliance when provisioning a new VM on the appliance.

### The Clone Process:

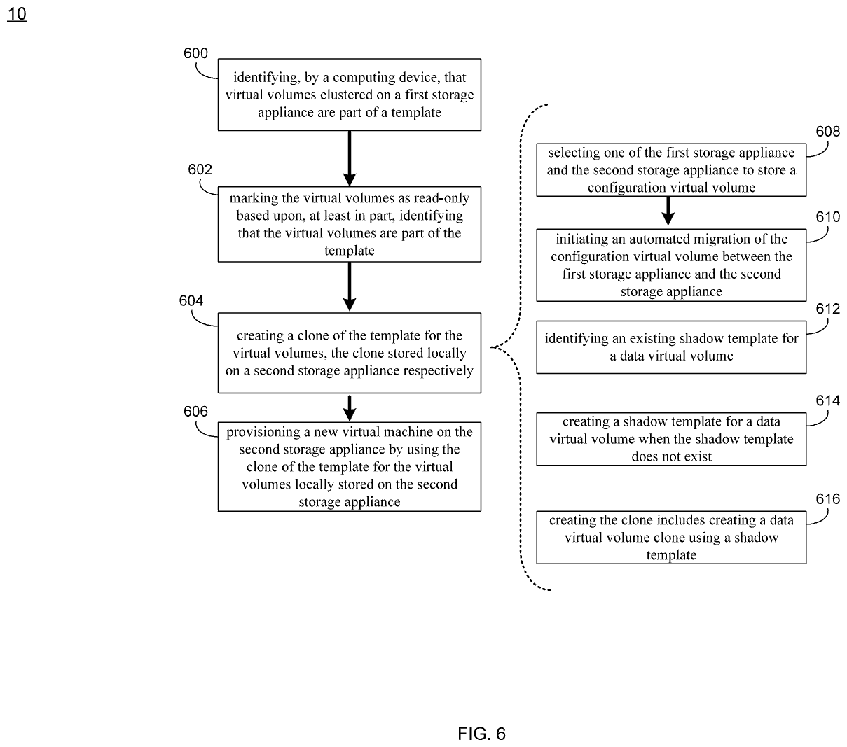

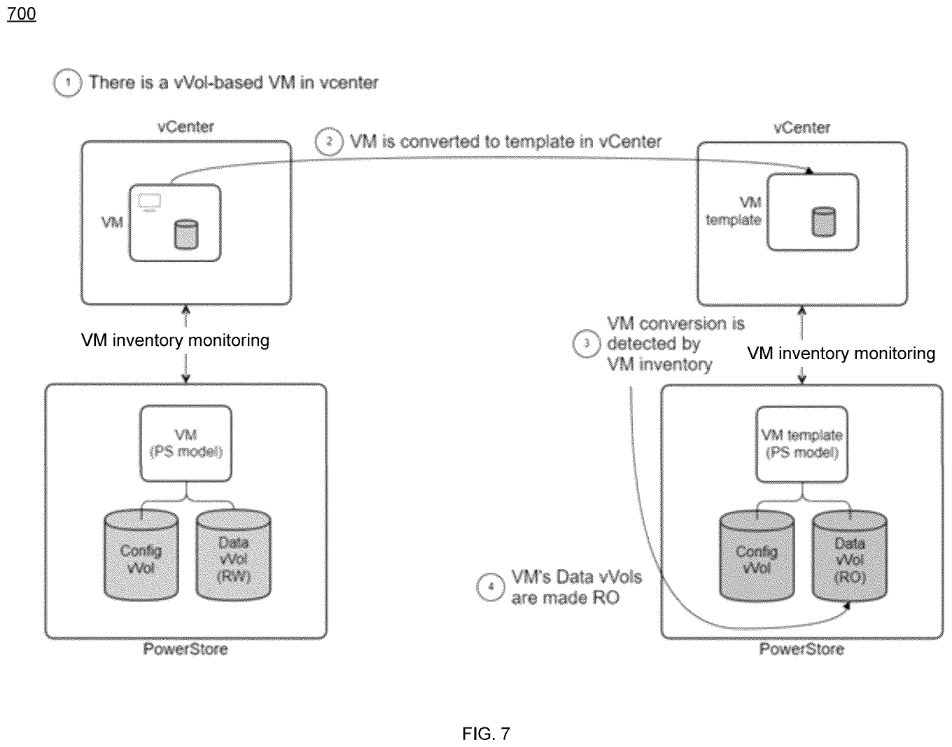

As discussed above and referring also at least to the example implementations of FIGS. 6-7, clone process 10 may identify 600, by a computing device, that virtual volumes clustered on a first storage appliance are part of a template. Clone process 10 may mark 602 the virtual volumes as read-only based upon, at least in part, identifying that the virtual volumes are part of the template. Clone process 10 may create 604 a clone of the template for the virtual volumes, the clone stored locally on a second storage appliance. Clone process 10 may provision 606 a new virtual machine on the second storage appliance by using the clone of the template for the virtual volumes locally stored on the second storage appliance.

In some implementations, clone process 10 may identify 600, by a computing device, that virtual volumes clustered (e.g., a scale-out cluster) on a first storage appliance are part of a template, and in some implementations, clone process 10 may mark 602 the virtual volumes as read-only based upon, at least in part, identifying that the virtual volumes are part of the template. For example, the fact that vVols are being a part of a template cannot (generally) be identified by vVols themselves. Instead, clone process 10 may identify 600 a template vVol by acquiring this information automatically from an API (e.g., vSphere API or similar API from different storage management applications and architectures). PowerStore already has a vSphere integration feature, where clone process 10 may identify vVol-based VMs stored in a cluster and establishes vVol-VM relation, and this feature may be used in the PowerStore UI to map vVols to the VM(s). The code may be extended to check if VMs are templates and mark template vVols with a special flag (or other marking technique). Referring at least to the example implementation of FIG. 7, an alternative/additional process 700 of clone process 10 demonstrating the above approach is shown. Once the vVol is identified to be a template, clone process 10 may mark 602 it read-only to make sure data are not changed.

In some implementations, clone process 10 may create 604 a clone of the template for the virtual volumes, the clone stored locally on a second storage appliance, and in some implementations, clone process 10 may provision 606 a new virtual machine on the second storage appliance by using the clone of the template for the virtual volumes locally stored on the second storage appliance. As of now, the template will be on just the first appliance. As will be discussed further below, the template data vVol will be placed on the second (or third or fourth) appliances. For example, clone process 10 may issue clone vVol operations on template vVols when it is requested to deploy a VM from a template. As will be discussed below, clone process 10 may use copies of the template vVol on other appliances in the cluster and may be referred to as “shadow template” vVols. In this context, “shadow” is a copy of an object used for internal purposes only. Clone process 10 may use these copies in order to create other objects which are not internal and are exposed to external systems (like vSphere). Shadow copies are managed by PowerStore (e.g., via clone process 10), they may be created, deleted and updated automatically. These shadow template vVols will be exposed to users in the above-noted UI to show the benefit of PowerStore scale-out and to indicate the clone count derived from the shadow template vVols. Similar terms like “Shadow Snapshots” may be used in replication context for internal vVols, which are used as intermediate destinations during a synchronization process. By using a shadow template data vVol, clone process 10 (e.g., via the VM clone) has all its vVols local to the second appliance.

In some implementations, the creation of the Config vVol happens first and is followed by the clone for the data vVol. At the time of creation of the Config vVol, there is no lookahead available for the data vVols that might be involved. So, the placement for the Config vVol creation is a best effort initially.

In some implementations, creating 604 the clone may include selecting 608 one of the first storage appliance and the second storage appliance to store a configuration virtual volume. For example, based on capacity and performance metrics of the storage appliances, a Resource Balancer (such as the one used in PowerStore) may select 608 an appliance to place the Config vVol. It will be appreciated that the Resource Balancer may be part of clone process 10. In some implementations, even though there may be multiple template VMs, the creation of the clones themselves are usually bursty in that a bunch of VM clones will be created one after another. The Resource Balancer of clone process 10 may help track the creation of the last few VM clones to get an idea of which VM template might be in use.

For the first few clones of a template VM, the VM clones may be place on the same appliance as the template VM that was least frequently used since that storage appliance might have compute and storage capacity to handle the new VM clones. Clone process 10 may direct the creation of the Config vVol for the initial set of clone VMs to be created on the same appliance as this chosen template VM. In some implementations, if clone process 10 decides that the compute or capacity is above a threshold on the original appliance, clone process 10 may decide to place the Config vVol for the new VM clone on the next best appliance in the cluster. The exact heuristic for the threshold is based on the platform type of the appliances in the cluster and their current usage of compute and storage resources.

In some implementations, in a cluster, clone process 10 may need to ensure the best storage efficiency for the customer solution by using minimal appliances in the cluster as needed for that specific template VM. Spreading the clones across all appliances in a cluster when not necessitated due to capacity or performance considerations may decrease storage efficiency of the solution. So, based on usage of all template VMs and their clones, the spread of a specific template VM may be based on factors such as number of clone VMs and the usage characteristics of each. This aspect is mentioned for completeness.

In some implementations, creating 604 the clone may further include initiating 610 an automated migration of the configuration virtual volume between the first storage appliance and the second storage appliance. For example, because of the requirement mentioned above, when the request for a clone for data vVol is received, clone process 10 may adjust the appliance location of the VM. Note that the appliance for the template VM was chosen initially based on the creation of the Config vVol. It was a best effort at that time. So, when a correct choice of appliance is made for the clone data vVol, it may require changing where the Config vVol for that VM exists and limit the number of appliances in which a specific data vVol template is spread across the cluster. As stated earlier, the Config vVols are very small vVols and have very little data when created. Based on the choice of the appliance for the clone data vVol, clone process 10 may need to initiate 610 an automated migration of the Config vVol between appliances. This ensures co-location of the Config vVol and the data vVol clone of a VM clone on the same appliance.

In some implementations, creating 604 the clone may include identifying 612 an existing shadow template for a data virtual volume. For example, once the appliance for a data vVol has been selected, clone process 10 may identify 612 an existing shadow template for the data vVol on the selected appliance where the Config vVol was created.

In some implementations, creating 604 the clone may include creating 614 a shadow template for a data virtual volume when the shadow template does not exist. For example, if the shadow template does not exist on the selected appliance, it will be created 614 and a copy will be started from the original template vVol.

In some implementations, creating 604 the clone may include creating 616 a data virtual volume clone using a shadow template. For example, the shadow template on the selected appliance may be used to create a Data vVol clone, which may be exposed (e.g., to vSphere or similar application). In some implementations, the first clone on a new appliance may take longer to create until the shadow template is fully populated.

In some implementations, changes made to the template may be applied to all further clones of the template. For example, a template was mentioned above to be immutable; however, it may be immutable only for a certain period of time. For instance, there may be scenario where changes need to be made to the template and this change applied to all future clones of the template. When a VM template needs to be updated, the template may be converted to a regular vVol and may be updated with the latest application version or patch or guest operating system version. The data vVol may be reconverted back to a template once it has been updated as needed. In some implementations, clone process 10 may detect this conversion from the template vVol and may delete the shadow template on other appliances.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. As used herein, the language “at least one of A, B, and C” (and the like) should be interpreted as covering only A, only B, only C, or any combination of the three, unless the context clearly indicates otherwise. It will be further understood that the terms “comprises” and/or “comprising,” when used in this specification, specify the presence of stated features, integers, steps (not necessarily in a particular order), operations, elements, and/or components, but do not preclude the presence or addition of one or more other features, integers, steps (not necessarily in a particular order), operations, elements, components, and/or groups thereof.

The corresponding structures, materials, acts, and equivalents (e.g., of all means or step plus function elements) that may be in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications, variations, substitutions, and any combinations thereof will be apparent to those of ordinary skill in the art without departing from the scope and spirit of the disclosure. The implementation(s) were chosen and described in order to explain the principles of the disclosure and the practical application, and to enable others of ordinary skill in the art to understand the disclosure for various implementation(s) with various modifications and/or any combinations of implementation(s) as are suited to the particular use contemplated.

Having thus described the disclosure of the present application in detail and by reference to implementation(s) thereof, it will be apparent that modifications, variations, and any combinations of implementation(s) (including any modifications, variations, substitutions, and combinations thereof) are possible without departing from the scope of the disclosure defined in the appended claims.

What is claimed is:

1. A computer-implemented method comprising:
identifying, by a computing device, that virtual volumes clustered on a first storage appliance are part of a template;
marking the virtual volumes as read-only based upon, at least in part, identifying that the virtual volumes are part of the template;
creating a clone of the template for the virtual volumes, the clone stored locally on a second storage appliance; and
provisioning a new virtual machine on the second storage appliance by using the clone of the template for the virtual volumes locally stored on the second storage appliance.

2. The computer-implemented method of claim 1 wherein creating the clone includes selecting one of the first storage appliance and the second storage appliance to store a configuration virtual volume.

3. The computer-implemented method of claim 2 wherein creating the clone further includes initiating an automated migration of the configuration virtual volume between the first storage appliance and the second storage appliance.

4. The computer-implemented method of claim 1 wherein creating the clone includes identifying an existing shadow template for a data virtual volume.

5. The computer-implemented method of claim 1 wherein creating the clone includes creating a shadow template for a data virtual volume when the shadow template does not exist.

6. The computer-implemented method of claim 1 wherein creating the clone includes creating a data virtual volume clone using a shadow template.

7. The computer-implemented method of claim 1 wherein changes made to the template are applied to all further clones of the template.

8. A computer program product residing on a computer readable storage medium having a plurality of instructions stored thereon which, when executed across one or more processors, causes at least a portion of the one or more processors to perform operations comprising:
identifying that virtual volumes clustered on a first storage appliance are part of a template;
marking the virtual volumes as read-only based upon, at least in part, identifying that the virtual volumes are part of the template;
creating a clone of the template for the virtual volumes, the clone stored locally on a second storage appliance; and
provisioning a new virtual machine on the second storage appliance by using the clone of the template for the virtual volumes locally stored on the second storage appliance.

9. The computer program product of claim 8 wherein creating the clone includes selecting one of the first storage appliance and the second storage appliance to store a configuration virtual volume.

10. The computer program product of claim 9 wherein creating the clone further includes initiating an automated migration of the configuration virtual volume between the first storage appliance and the second storage appliance.

11. The computer program product of claim 8 wherein creating the clone includes identifying an existing shadow template for a data virtual volume.

12. The computer program product of claim 8 wherein creating the clone includes creating a shadow template for a data virtual volume when the shadow template does not exist.

13. The computer program product of claim 8 wherein creating the clone includes creating a data virtual volume clone using a shadow template.

14. The computer program product of claim 8 wherein changes made to the template are applied to all further clones of the template.

15. A computing system including one or more processors and one or more memories configured to perform operations comprising:
identifying that virtual volumes clustered on a first storage appliance are part of a template;
marking the virtual volumes as read-only based upon, at least in part, identifying that the virtual volumes are part of the template;
creating a clone of the template for the virtual volumes, the clone stored locally on a second storage appliance; and
provisioning a new virtual machine on the second storage appliance by using the clone of the template for the virtual volumes locally stored on the second storage appliance.

16. The computing system of claim 15 wherein creating the clone includes selecting one of the first storage appliance and the second storage appliance to store a configuration virtual volume.

17. The computing system of claim 16 wherein creating the clone further includes initiating an automated migration of the configuration virtual volume between the first storage appliance and the second storage appliance.

18. The computing system of claim 15 wherein creating the clone includes at least one of:
identifying an existing shadow template for a data virtual volume; and
creating a shadow template for a data virtual volume when the shadow template does not exist.

19. The computing system of claim 15 wherein creating the clone includes creating a data virtual volume clone using a shadow template.

20. The computing system of claim 15 wherein changes made to the template are applied to all further clones of the template.
